(19) United States
(12) Patent Application Publication
(10) Pub. No.: US 2018/0304772 A1
(43) Pub. Date: Oct. 25, 2018

(54) SEAT DRIVE DEVICE

(71) Applicant: TOYOTA BOSHOKU KABUSHIKI KAISHA, Aichi-ken (JP)

(72) Inventors: Yuji ARAKAWA, Aichi-ken (JP); Yoichi TAKADA, Aichi-ken (JP)

(73) Assignee: TOYOTA BOSHOKU KABUSHIKI KAISHA, Aichi-ken (JP)

(21) Appl. No.: 15/955,070

(22) Filed: Apr. 17, 2018

(30) Foreign Application Priority Data
Apr. 24, 2017 (JP) 2017-085124

(51) Int. Cl. B60N 2/02; B60N 2/30; B60N 2/829; B60N 2/90; B60N 2/20; F16H 37/04

(52) U.S. Cl. CPC B60N 2/0232; B60N 2/3004; B60N 2/829; B60N 2002/0236; B60N 2/20; F16H 37/043; B60N 2/99

(57) ABSTRACT

A seat drive device for a seat in which a seat frame is arranged along an outer shape of the seat and positions of a plurality of seat moving parts are adjustable, the seat drive device including: a motor fixed to an outer portion of the seat frame and having a single output shaft; driving shafts arranged in parallel and receiving output of the motor via a gear; wherein the output shaft of the motor and the driving shafts are arranged in parallel to each other such that an axis of the output shaft of the motor and axes of the driving shafts extend along the outer portion of the seat frame, and each distance between each of the driving shafts and the outer portion of the seat frame is smaller than a distance between the output shaft of the motor and the outer portion of the seat frame.

### CROSS-REFERENCE TO RELATED APPLICATIONS

This application claims priority from Japanese Patent Application No. 2017-085124 filed on Apr. 24, 2017, the entire contents of which are incorporated herein by reference.

### TECHNICAL FIELD

The disclosure relates to a seat drive device for adjusting positions of a plurality of seat moving parts by a single motor.

### BACKGROUND

A seat drive device for adjusting positions of a plurality of seat moving parts by a single motor is disclosed in JP-A-2016-141301. Such a seat drive device is configured to perform position adjustment (seat back folding adjustment, headrest height adjustment, and side support adjustment) of three seat moving parts by using a single motor. Specifically, the output of the motor is distributed to three drive shafts and transmitted from each of the drive shafts to each position adjustment mechanism via a clutch mechanism.

In a seat such as a vehicle seat, it is necessary to adopt a configuration in which an operation of a position adjustment mechanism of a seat moving part is performed within the reach of a seated occupant's hand. Generally, an operation part is provided on a side portion of a seat cushion.

However, in a case of the seat drive device described above, since components of a mechanism for operating and driving are concentrated in one place and become larger, an operation part projects outward from an outer shape of a seat. Therefore, a gap between the operation part and members in the vicinity of the seat may not be sufficiently secured. Thus, there is a problem that an operation space of the operation part is small and operability is poor.

### SUMMARY

The disclosure provides a seat drive device which adjusts positions of a plurality of seat moving parts by a single motor and in which an amount of protrusion of the seat drive device from an outer shape of a seat is reduced by reducing a gap between the seat drive device to a portion of the seat on which the seat drive device is mounted.

According to an aspect of the disclosure, there is provided a seat drive device for a seat in which a seat frame serving as a framework member is arranged along an outer shape of the seat and positions of a plurality of seat moving parts are adjustable, the seat drive device including: a motor fixed to an outer portion of the seat frame and having a single output shaft; a plurality of driving shafts arranged in parallel and configured to receive output of the motor via a gear; a plurality of position adjustment mechanisms configured to be actuated by the respective driving shafts and configured to adjust the positions of the respective seat moving parts; a plurality of clutch mechanisms disposed corresponding to the respective position adjustment mechanisms and configured to individually and selectively connect output shafts to the respective position adjustment mechanisms and the driving shafts; a switch configured to switch the motor to an energized state or a non-energized state; an operation knob configured to be operated when adjusting the positions of the respective seat moving parts; and an operation mechanism configured to switch the respective clutch mechanisms to a connected state or a non-connected state and configured to operate the switch by receiving an operating force of the operation knob, wherein the operation mechanism and the operation knob are disposed on an opposite of the seat frame with the driving shafts interposed therebetween, and wherein the output shaft of the motor and the plurality of driving shafts are arranged in parallel to each other such that an axis of the output shaft of the motor and axes of the plurality of driving shafts extend along the outer portion of the seat frame, and each distance between each of the plurality of driving shafts and the outer portion of the seat frame is smaller than a distance between the output shaft of the motor and the outer portion of the seat frame.

In the above-described aspect, the number of the seat moving parts and the position adjustment mechanisms may be two or three or more. Various types of clutch mechanisms and switches known in the art can be adopted. The operation knob for the clutch mechanisms and the operation knob for the switches may be integrally provided or may be separately provided.

According to the above-described aspect, the position of the output shaft of the motor is determined by fixing the motor to the seat frame. The positions of the driving shafts are made closer to the side of the seat frame with respect to the output shaft. Therefore, the amount of protrusion from the seat frame of the operation mechanism and the operation knob, which are arranged on the opposite side of the seat frame with the driving shafts interposed therebetween, is reduced. In this way, it is possible to secure a wide space between the operation part and members in the vicinity of the seat. As a result, it is possible to suppress the degradation of operability due to a small operation space of the operation part.

### BRIEF DESCRIPTION OF DRAWINGS

FIG. 1 is a side view of a vehicle front seat to which a seat drive device according to an embodiment of the disclosure is applied;

FIG. 2 is a plan view of the same vehicle front seat as FIG. 1;

FIG. 3 is a schematic system explanatory view of the embodiment;

FIG. 4 is a sectional view taken along the line IV-IV in FIG. 1;

FIG. 5 is a sectional view taken along the line V-V in FIG. 1;

FIG. 6 is a perspective view of an operation mechanism in the embodiment;

FIG. 7 is a front view of the operation mechanism in the embodiment;

FIG. 8 is a rear view of the operation mechanism in the embodiment;

FIG. 9 is an enlarged sectional view of a center cam part of the operation mechanism in the embodiment;

FIG. 10 is an enlarged side view showing a state in which an operation knob and the operation mechanism are removed in the embodiment;

FIG. 11 is a sectional view taken along the line XI-XI in FIG. 10; and

FIG. 12 is an explanatory view corresponding to FIG. 11, showing a modification of the embodiment.

### DETAILED DESCRIPTION

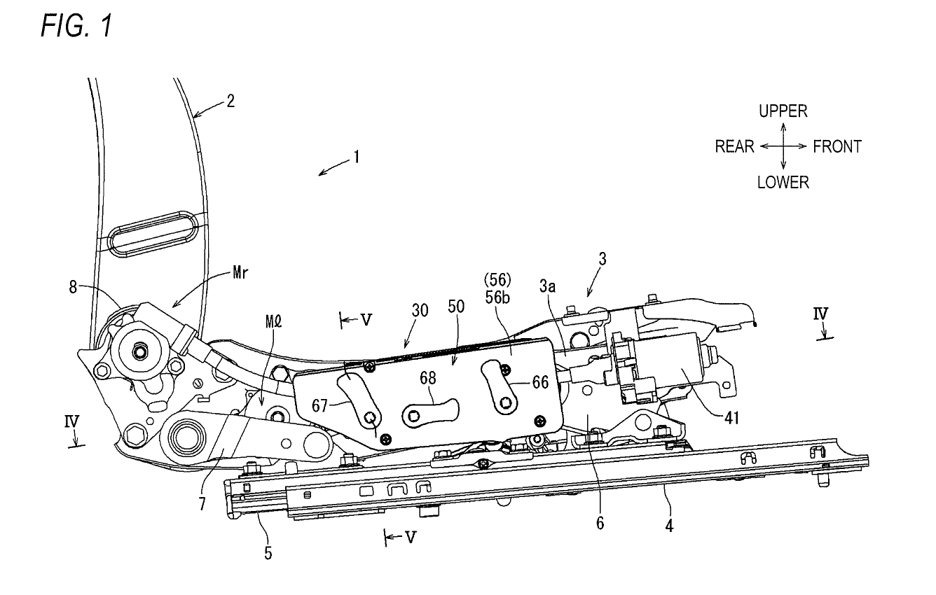

FIGS. 1 to 11 show an embodiment of the disclosure. This embodiment represents an example in which the seat drive device of the disclosure is applied to a vehicle front seat (hereinafter, simply referred to as a “seat”) 1. In each drawing, respective directions in the state where the seat 1 is mounted to a vehicle are indicated by arrows. In the following, the descriptions relating to the directions will be made based on these directions.

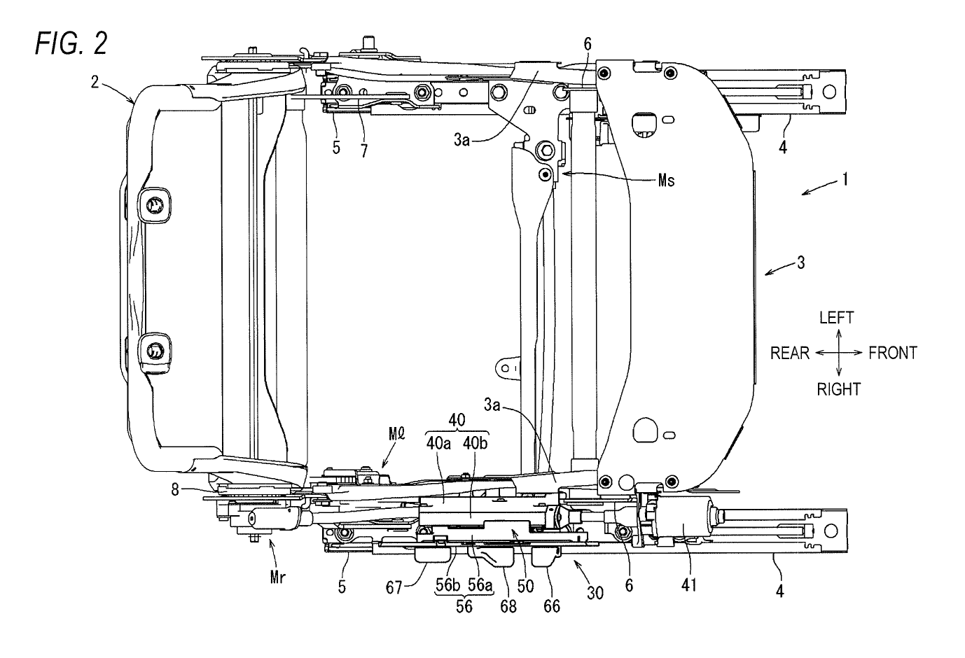

FIGS. 1 and 2 show an appearance of the seat 1. However, in this embodiment, the seat 1 represents only the configurations of framework members. In the seat 1, a seat back 2 forming a backrest is fixed to the rear side of a seat cushion 3 forming a seating part so as to be rotatable back and forth. Therefore, a recliner 8 for adjusting a reclining angle of the seat back 2 is provided at a hinge portion between a rear portion of the seat cushion 3 and a lower portion of the seat back 2. A cushion frame 3a that is a framework member of the seat cushion 3 corresponds to the “seat frame” in the disclosure.

The seat 1 is fixed on a vehicle floor (not shown) so as to be movable back and forth. Therefore, a pair of lower rails 4 is fixed on the vehicle floor below both left and right side portions of the seat cushion 3. Further, upper rails 5 are fitted into the lower rails 4, respectively. The upper rails 5 are slidable in a front and rear direction with respect to the lower rails 4 below both left and right side portions of the seat cushion 3.

The seat cushion 3 is fixed on each of the upper rails 5 by a front link 6 and a rear link 7 via brackets, respectively. The front link 6 and the rear link 7 are tiltable in the front and rear direction with respect to the upper rails 5. Therefore, the height of the seat 1 from the vehicle floor can be adjusted (lifter adjustment can be made) by adjusting the angles of the front link 6 and the rear link 7.

In this manner, the seat 1 is configured such that reclining angle adjustment, slide adjustment and lifter adjustment can be made. That is, the seat 1 is configured as a so-called 6-way power seat. A reclining angle adjustment mechanism Mr for performing the reclining angle adjustment is provided in the recliner 8 below the seat back 2. Further, a slide adjustment mechanism Ms for performing the slide adjustment is provided on a rod (not shown) for sliding the left and right upper rails 5. Furthermore, a lifter adjustment mechanism Ml for performing the lifter adjustment is provided on a gear (not shown) for rotationally driving the rear link 7. Accordingly, the seat moving part in the disclosure refers to the recliner 8, the upper rails 5 and the rear link 7.

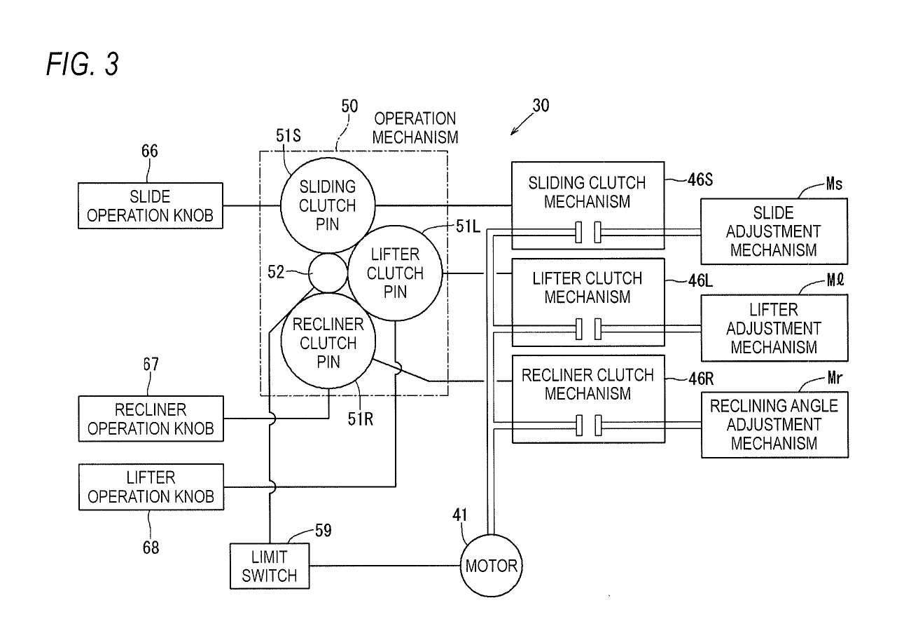

As shown in FIG. 3, the slide adjustment mechanism Ms, the lifter adjustment mechanism Ml and the reclining angle adjustment mechanism Mr are connected to a motor 41 having a single output shaft via a sliding clutch mechanism 46S, a lifter clutch mechanism 46L and a recliner clutch mechanism 46R, respectively. Therefore, the respective adjustment mechanisms Ms, Ml, Mr are selectively actuated when the corresponding one of the clutch mechanisms 46S, 46L, 46R is connected and the motor 41 is actuated. Each of the sliding clutch mechanism 46S, the lifter clutch mechanism 46L and the recliner clutch mechanism 46R is a clutch mechanism which is normally in a non-connected state, and is brought into a connected state when a sliding clutch pin 51S, a lifter clutch pin 51L and a recliner clutch pin 51R of an operation mechanism 50 are rotated. The sliding clutch pin 51S, the lifter clutch pin 51L and the recliner clutch pin 51R are rotated when a slide operation knob 66, a recliner operation knob 67 and a lifter operation knob 68 are rotated, respectively.

A center cam 52 which is surrounded by the sliding clutch pin 51S, the lifter clutch pin 51L and the recliner clutch pin 51R is provided. When one of the sliding clutch pin 51S, the lifter clutch pin 51L and the recliner clutch pin 51R is rotated, the center cam 52 turns on (energizes) a limit switch (corresponding to a switch in the disclosure) 59 and actuates the motor 41.

In this manner, when one of the slide operation knob 66, the recliner operation knob 67 and the lifter operation knob 68 is operated, the corresponding one of the clutch mechanisms 46S, 46L, 46R are brought into a connected state via the corresponding one of the sliding clutch pin 51S, the lifter clutch pin 51L and the recliner clutch pin 51R. Simultaneously, since the limit switch 59 is turned on by the center cam 53, the motor 41 is actuated and the corresponding one of the adjustment mechanisms Ms, Ml, Mr is actuated.

As shown in FIGS. 1 and 2, a driving device 30 for the seat drive device, which enables the adjustment of the positions of a plurality of seat moving parts according to the preference of an occupant seated on the seat 1, is provided on a right side portion of the cushion frame 3a of the seat cushion 3. The slide operation knob 66, the lifter operation knob 68 and the recliner operation knob 67 configuring an operation member of the driving device 30 protrude to the right side of a gear casing 56 so that it can be operated by the seated occupant. A clutch casing 40 is provided on the left side of the gear casing 56, and the motor 41 is fixed to the front side of the clutch casing 40. The operation mechanism 50 is incorporated in the gear casing 56, and the clutch mechanisms 46S, 46L, 46R are incorporated in the clutch casing 40.

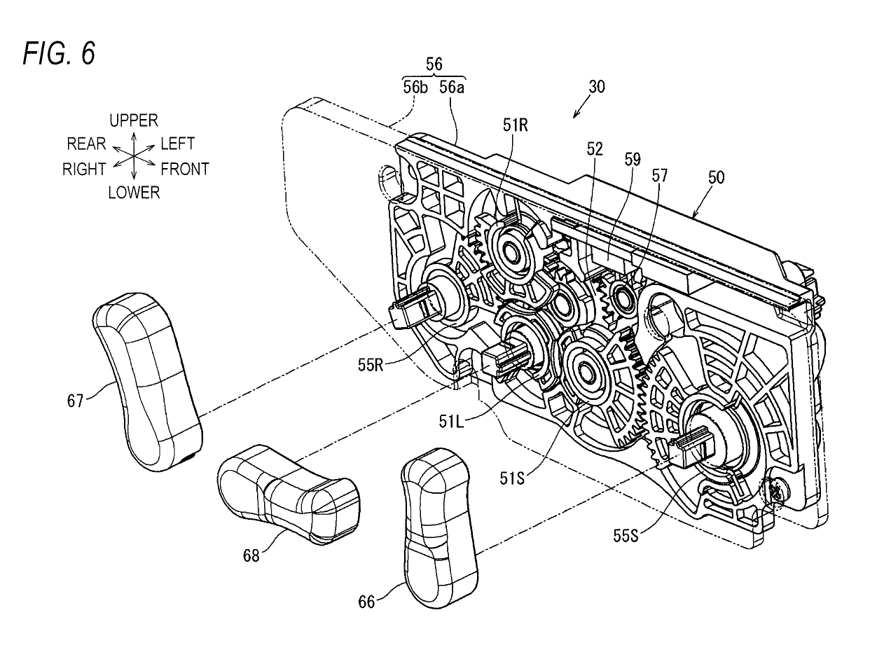

As shown in FIG. 6, each of the slide operation knob 66 and the lifter operation knob 68 is an operation knob of a type that is rotated about a hinge portion. A hinge portion of the slide operation knob 66 is engaged with a rotation center portion of a sliding drive gear 55S in a rotation direction. As the slide operation knob 66 is rotated, the sliding drive gear 55S is rotated. The sliding drive gear 55S is meshed so as to rotate the sliding clutch pin 51S. Therefore, by operating the slide operation knob 66, the sliding clutch pin 51S is operated via the sliding drive gear 55S.

A hinge portion of the lifter operation knob 68 is engaged with a rotation center portion of the lifter clutch pin 51L in the rotation direction. As the lifter operation knob 68 is rotated, the lifter clutch pin 51L is rotated. Therefore, the lifter clutch pin 51L is operated by the operation of the lifter operation knob 68.

The recliner operation knob 67 is an operation knob of the type which has a shape similar to the side shape of the seat back 2 in a front view and in which an upper portion is pivoted about a lower end portion. The lower end portion of the recliner operation knob 67 is engaged with a rotation center portion of a recliner drive gear 55R in the rotation direction. As the upper portion of the recliner operation knob 67 is rotated, the recliner drive gear 55R is rotated. The recliner drive gear 55R is meshed so as to rotate the recliner clutch pin 51R. Therefore, by operating the recliner operation knob 67, the recliner clutch pin 51R is operated via the recliner drive gear 55R.

The sliding clutch pin 51S, the lifter clutch pin 51L and the recliner clutch pin 51R are accommodated in the gear casing 56 including gear casing halves 56a, 56b. Therefore, the gear casing half 56b is located on the left side of the slide operation knob 66, the lifter operation knob 68 and the recliner operation knob 67, and the sliding clutch pin 51S, the lifter clutch pin 51L and the recliner clutch pin 51R or the like in the gear casing 56 are not exposed to the outside.

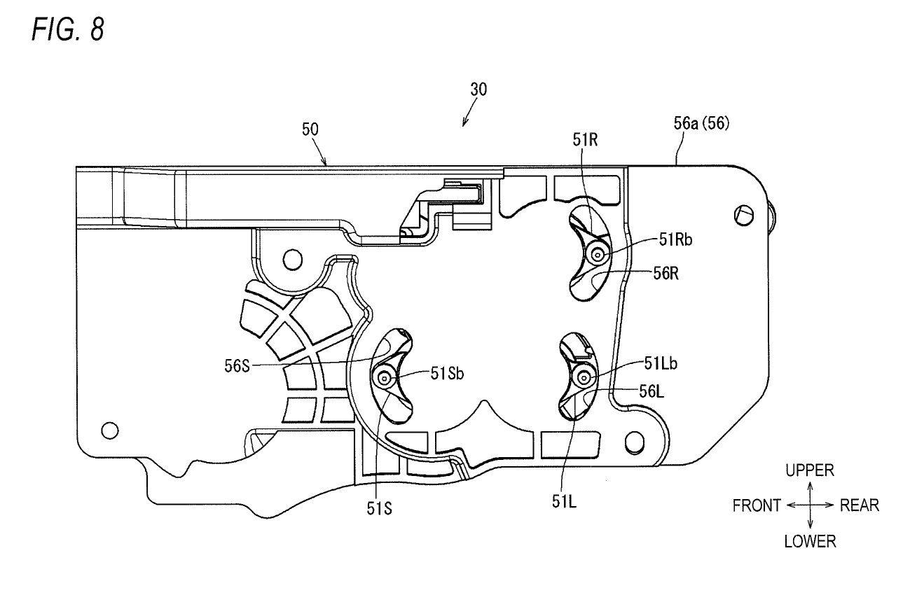

As shown in FIG. 8, arcuate through-holes 56S, 56L, 56R are formed at the positions of the gear casing half 56a corresponding to the sliding clutch pin 51S, the lifter clutch pin 51L and the recliner clutch pin 51R. Projections 51Sb, 51Lb, 51Rb protruded on the left side of the sliding clutch pin 51S, the lifter clutch pin 51L and the recliner clutch pin 51R are protruded to the outside of the gear casing 56 through the through-holes 56S, 56L, 56R. Further, the through-holes 56S, 56L, 56R are formed along movement trajectories of the projection 51Sb, 51Lb, 51Rb, respectively.

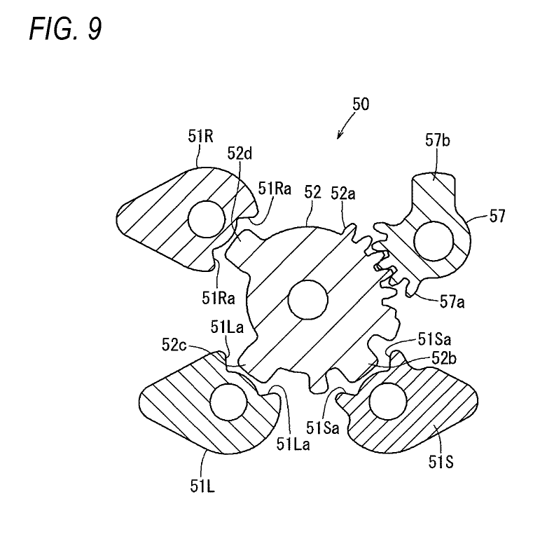

As shown in FIG. 9, projections 52b to 52d are provided in the center cam 52. Each of the projections 52b to 52d protrudes in a radial direction so as to correspond to each of the clutch pins 51S, 51L, 51R. Engaging portions 51Sa, 51La, 51Ra are provided so as to face each other on both sides of each of the projections 52b to 52d in a circumferential direction. When one of the clutch pins 51S, 51L, 51R is rotated, the projections 52b to 52d are engaged by the engaging portions 51Sa, 51La, 51Ra, so that the center cam 52 is rotated.

In this manner, the center cam 52 is rotated when one of the sliding clutch pin 51S, the lifter clutch pin 51L and the recliner clutch pin 51R has been rotated. However, the projections 52b to 52d and the engaging portions 51Sa, 51La, 51Ra are separated from each other in the rotation direction so that the sliding clutch pin 51S, the lifter clutch pin 51L and the recliner clutch pin 51R, which have not been rotated, are not rotated by the influence of the rotated center cam 52.

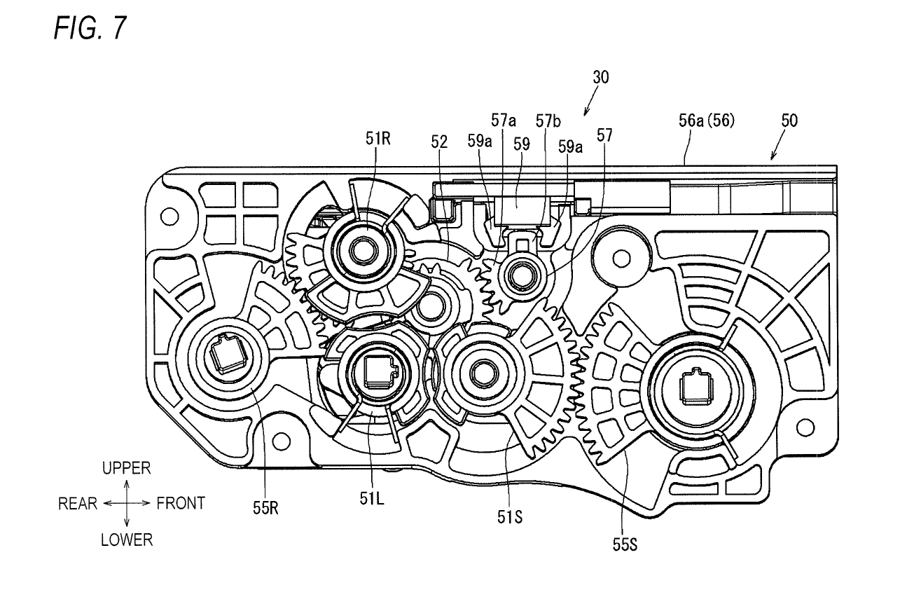

A gear portion 52a is formed at the position on the outer periphery of the center cam 52 where the projections 52b to 52d are not provided. A gear portion 57a of a switch link 57 is meshed with the gear portion 52a of the center cam 52. As shown in FIG. 7, when the switch link 57 is rotated in response to the rotation of the center cam 52, one of operation pieces 59a of the limit switch 59 is operated by a protruding piece 57b of the switch link 57 according to the rotation direction. The limit switch 59 is energized according to the operated operation piece 59a and is connected to an electrical circuit so as to supply power having different polarities to the motor 41 (not shown). Therefore, the motor 41 is rotationally driven in a direction corresponding to the rotation direction of the center cam 52.

As described above, the projections 52b to 52d and the engaging portions 51Sa, 51La, 51Ra are separated from each other, and the protruding piece 57b of the switch link 57 and each operation piece 59a of the limit switch 59 are also separated from each other. Therefore, the timing at which the limit switch 59 is energized by the rotation of one of the sliding clutch pin 51S, the lifter clutch pin 51L and the recliner clutch pin 51R is made slower than the timing at which the sliding clutch mechanism 46S, the lifter clutch mechanism 46L and the recliner clutch mechanism 46R are brought into a connected state. Therefore, the motor 41 is prevented from being actuated before the clutch mechanisms 46S, 46L, 46R are switched.

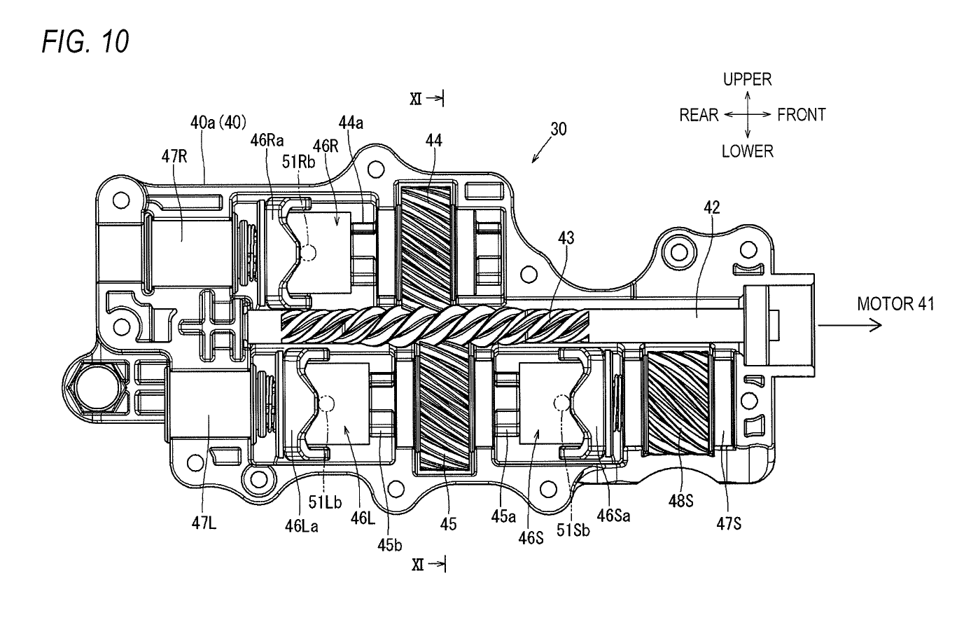

FIG. 10 shows the driving mechanism part of the driving device 30 accommodated in the clutch casing 40. The driving mechanism part of the driving device 30 includes the motor 41. The motor 41 has a single motor output shaft 42. A helical gear 43 is coupled to the motor output shaft 42. A pair of helical gears 44, 45 dispersed in an up and down direction is meshed with the helical gear 43. Therefore, a combination of the helical gear 43 and the helical gears 44, 45 causes uniaxial rotation output from the motor 41 to be converted into biaxial rotation output.

Clutch mechanisms are coupled to driving shafts which are coupled to the helical gears 44, 45 and arranged in parallel with each other, respectively. That is, the recliner clutch mechanism 46R is detachably coupled to a driving shaft 44a of the helical gear 44. Further, the sliding clutch mechanism 46S is detachably coupled to a driving shaft 45a on the front side of the helical gear 45, and the lifter clutch mechanism 46L is detachably coupled to a driving shaft 45b on the rear side of the helical gear 45.

The clutch mechanisms 46S, 46L, 46R include operation members 46Sa, 46La, 46Ra for switching the clutch mechanisms 46S, 46L, 46R from a non-connected state to a connected state by a rocking operation, respectively. FIG. 10 shows a state in which the clutch mechanisms 46S, 46L, 46R are in a non-connected state and the rotation of the driving shafts 44a, 45a, 45b is not transmitted to the clutch mechanisms 46S, 46L, 46R. In FIG. 10, when the operation members 46Ra, 46La are swung forward, the clutch mechanisms 46R, 46L are brought into a connected state, and the rotation of the driving shafts 44a, 45b is transmitted to the clutch mechanisms 46R, 46L. On the other hand, when the operation member 46Sa is swung rearward, the sliding clutch mechanism 46S is brought into a connected state, and the rotation of the driving shaft 45a is transmitted to the sliding clutch mechanism 46S. These operation members 46Sa, 46La, 46Ra are operated by the projections 51Sb, 51Lb, 51Rb of the corresponding clutch pins 51S, 51L, 51R (see FIG. 8).

A helical gear 48S is coupled to an output shaft 47S of the sliding clutch mechanism 46S. A helical gear (not shown) having a driving shaft arranged in a direction intersecting with a driving shaft of the helical gear 48S is meshed with the helical gear 48S. A combination of the helical gear 48S and the helical gear (not shown) causes an axial direction of the output shaft 47S of the sliding clutch mechanism 46S to be converted. Meanwhile, axial directions of an output shaft 47R of the recliner clutch mechanism 46R and an output shaft 47L of the lifter clutch mechanism 46L are not converted.

The output shafts 47S, 47L, 47R are coupled to the slide adjustment mechanism Ms, the lifter adjustment mechanism Ml and the reclining angle adjustment mechanism Mr via torque cables, respectively.

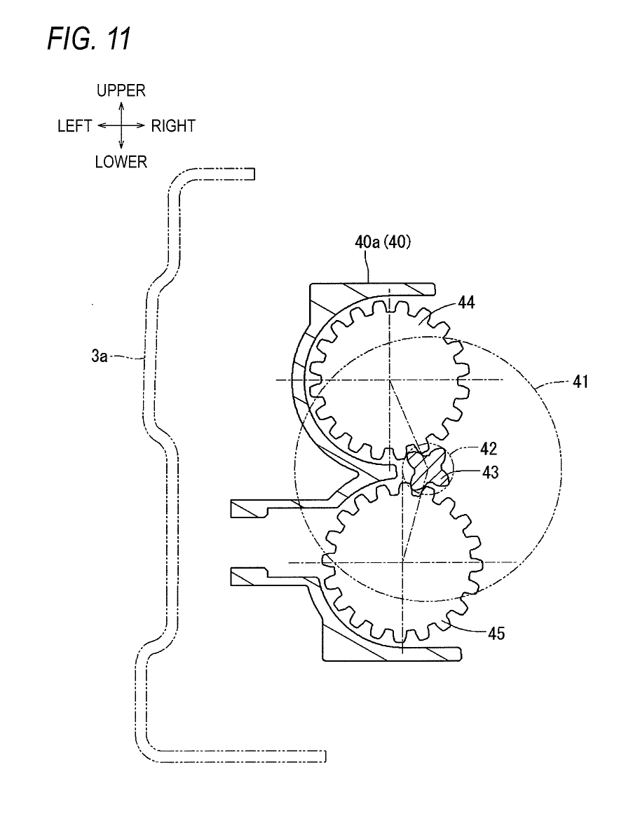

As shown in FIG. 11, the rotation axes of the helical gears 44, 45 are biased to the left side (to the side of the cushion frame 3a) with respect to the rotation axes of the motor output shaft 42 and the helical gear 43. That is, distances between the rotation axes of the helical gears 44, 45 and the cushion frame 3a are made smaller than distances between the rotation axes of the motor output shaft 42 and the helical gear 43 and the cushion frame 3a. As a result, the driving shafts 44a, 45a, 45b and the output shafts 47R, 47S, 47L, and the clutch mechanisms 46R, 46S, 46L are all biased to the left side. The positions of the rotation axes of the motor output shaft 42 and the helical gear 43 are determined by the position of the motor 41. As shown in FIGS. 1, 2 and 4, the position of the motor 41 is determined by the fixing position of the motor 41 which is fixed to the cushion frame 3a by a bracket 41a. The portion of the cushion frame 3a to which the bracket 41a is attached corresponds to the “outer portion of the seat frame” in the disclosure.

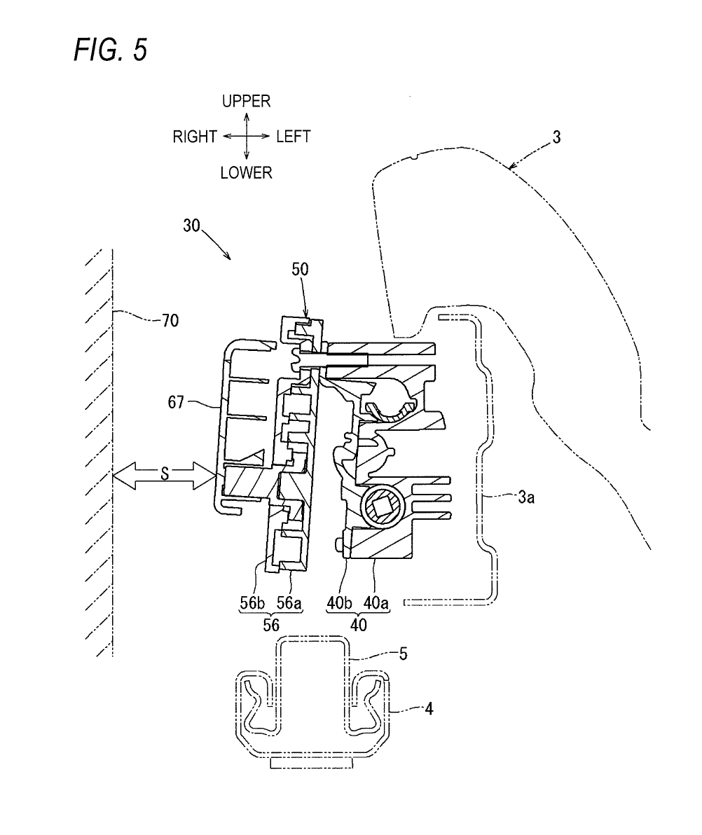

As shown in FIG. 11, the helical gears 44, 45 are biased to positions close to the left side end of the motor 41 and located at positions close to the cushion frame 3a. In this manner, as the helical gears 44, 45 are biased and the respective clutch mechanisms 46R, 46S, 46L are biased, the operation mechanism 50 including the respective clutch pins 51S, 51L, 51R is also biased to the side of the cushion frame 3a. Therefore, as shown in FIG. 5, it is possible to secure a wide space S between the operation knob 67 (66, 68) and a vehicle interior wall surface 70. As a result, it is possible to suppress the degradation of operability of the respective operation knobs 66, 67, 68 due to the narrow space S.

At this time, the biasing of the helical gears 44, 45 is performed by utilizing a dead space occurring when the motor 41 is fixed to the cushion frame 3a. That is, the diameters of the helical gears 44, 45 are made smaller than the outer diameter of the motor 41. Therefore, the structure of the seat cushion 3 is not affected at all even when the helical gears 44, 45 are biased to the side of the cushion frame 3a.

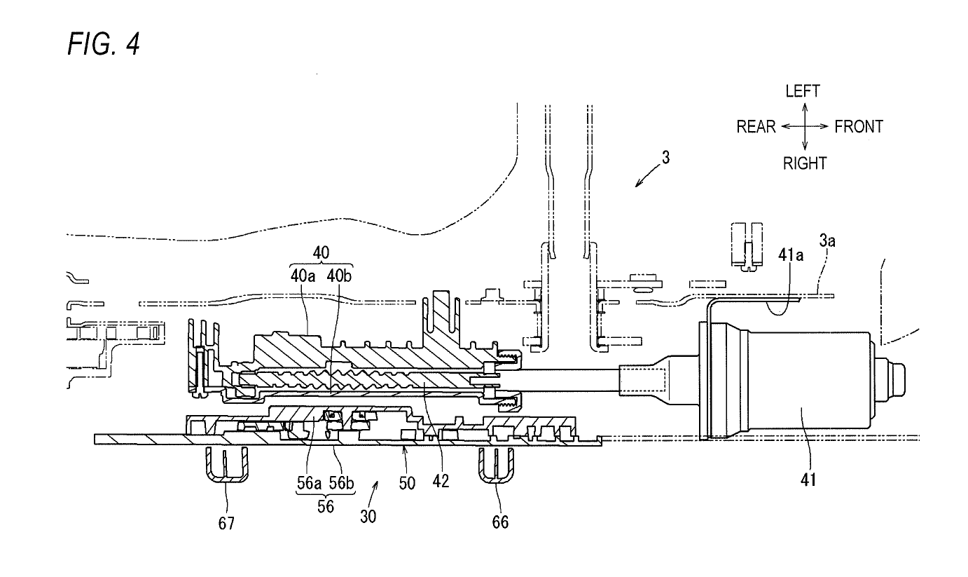

Members such as the clutch mechanisms 46S, 46L, 46R configuring the driving mechanism part of the driving device 30 are accommodated in a clutch casing half 40a (see FIG. 10). The clutch casing half 40a is combined with a clutch casing half 40b to form the clutch casing 40 that is a single casing member. On the other hand, members such as the clutch pins 51S, 51L, 51R configuring the operation mechanism part of the driving device 30 are accommodated in the gear casing half 56a (see FIGS. 4 to 6). The gear casing half 56a is combined with the gear casing half 56b to form the gear casing 56 that is a single casing member. Furthermore, the clutch casing 40 and the gear casing 56 are integrally combined, so that the movement of the respective clutch pins 51S, 51L, 51R is transmitted to the operation members 46Ra, 46Sa, 46La of the respective clutch mechanisms 46R, 46S, 46L.

According to the above embodiment, when the slide operation knob 66 is operated to rotate, the sliding clutch pin 51S is rotated via the sliding drive gear 55S and the operation member 46Sa of the sliding clutch mechanism 46S is operated. As a result, the sliding clutch mechanism 46S is brought into a connected state. On the other hand, since the center cam 52 is also rotated when the sliding clutch pin 51S is rotated, the limit switch 59 is switched to an energized state via the switch link 57. Therefore, the motor 41 is rotated in a direction corresponding to the rotation direction of the slide operation knob 66, and the slide adjustment mechanism Ms is actuated via the sliding clutch mechanism 46S.

Similarly also when the recliner operation knob 67 or the lifter operation knob 68 is operated to rotate, the recliner clutch pin 51R or the lifter clutch pin 51L is rotated, and the operation member 46Ra or 46La of the recliner clutch mechanism 46R or the lifter clutch mechanism 46L is operated. As a result, the recliner clutch mechanism 46R or the lifter clutch mechanism 46L is brought into a connected state. At this time, the limit switch 59 is energized by the rotation of the center cam 52, and the motor 41 is rotated. In this way, the reclining angle adjustment mechanism Mr or the lifter adjustment mechanism Ml is actuated.

Although specific embodiments have been described above, the disclosure is not limited to the appearances and configurations in these embodiments, and various modifications, additions and deletions can be made without changing the spirit of the disclosure. For example, in the above embodiments, the slide adjustment mechanism Ms, the lifter adjustment mechanism Ml and the reclining angle adjustment mechanism Mr are provided as the plurality of position adjustment mechanisms. However, the disclosure is not limited to such a configuration. That is, at least a part of the plurality of position adjustment mechanisms may be replaced by another position adjustment mechanism. Alternatively, another position adjustment mechanism may be added.

In the above embodiment, the seat drive device of the disclosure is fixed to the cushion frame of the seat cushion. However, the seat drive device of the disclosure may be fixed to the back frame of the seat back.

In the above embodiment, the disclosure is applied to a vehicle seat. However, the disclosure may be applied to a seat mounted on an airplane, a ship, a train, and the like. Further, the disclosure may be applied to a seat installed indoors, such as a seat in a movie theater.

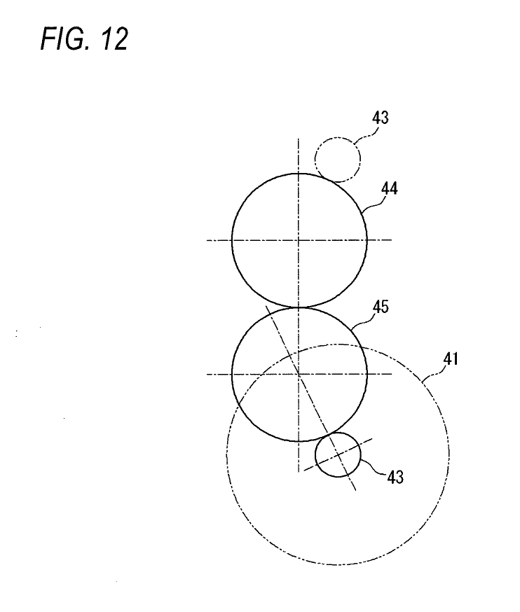

In the above embodiment, as shown in FIG. 11, the helical gears 44, 45 are arranged adjacent to the motor output shaft 42 and the helical gear 43, so that the helical gears 44, 45 are directly driven by the helical gear 43. Such a configuration may be changed as shown in FIG. 12. That is, the helical gear 45 may be directly driven by the helical gear 43, and the helical gear 44 may be driven by the helical gear 45. Here, as shown by an imaginary line, the helical gear 44 may be directly driven by the helical gear 43, and the helical gear 45 may be driven by the helical gear 44. Such modification can be applied to the case where the arrangement of the motor 41 and the clutch casing 40 cannot be made as shown in FIG. 11. However, in the case of the modification, one of the helical gears 44, 45 is not directly driven by the helical gear 43 but is indirectly driven, so there is a disadvantage that power transmission efficiency is degraded.

Also in the case of the modification shown in FIG. 12, similar to the case of the embodiment shown in FIG. 11, the helical gears 44, 45 are biased to positions close to the left side end of the motor 41 and located at positions close to the cushion frame 3a. Therefore, it is possible to secure a wide space S between the operation knob 67 (66, 68) and the vehicle interior wall surface 70. Here, in FIG. 12, the arrangement relationship of the helical gear 43 and the helical gears 44, 45 is mainly shown, and the description for the detailed shape and structure of each part is simplified.

The disclosure provides illustrative, non-limiting examples as follows:

According to a first aspect, there is provided a seat drive device for a seat in which a seat frame serving as a framework member is arranged along an outer shape of the seat and positions of a plurality of seat moving parts are adjustable, the seat drive device including: a motor fixed to an outer portion of the seat frame and having a single output shaft; a plurality of driving shafts arranged in parallel and configured to receive output of the motor via a gear; a plurality of position adjustment mechanisms configured to be actuated by the respective driving shafts and configured to adjust the positions of the respective seat moving parts; a plurality of clutch mechanisms disposed corresponding to the respective position adjustment mechanisms and configured to individually and selectively connect output shafts to the respective position adjustment mechanisms and the driving shafts; a switch configured to switch the motor to an energized state or a non-energized state; an operation knob configured to be operated when adjusting the positions of the respective seat moving parts; and an operation mechanism configured to switch the respective clutch mechanisms to a connected state or a non-connected state and configured to operate the switch by receiving an operating force of the operation knob, wherein the operation mechanism and the operation knob are disposed on an opposite of the seat frame with the driving shafts interposed therebetween, and wherein the output shaft of the motor and the plurality of driving shafts are arranged in parallel to each other such that an axis of the output shaft of the motor and axes of the plurality of driving shafts extend along the outer portion of the seat frame, and each distance between each of the plurality of driving shafts and the outer portion of the seat frame is smaller than a distance between the output shaft of the motor and the outer portion of the seat frame.

In the first aspect, the number of the seat moving parts and the position adjustment mechanisms may be two or three or more. Various types of clutch mechanisms and switches known in the art can be adopted. The operation knob for the clutch mechanisms and the operation knob for the switches may be integrally provided or may be separately provided.

According to the first aspect, the position of the output shaft of the motor is determined by fixing the motor to the seat frame. The positions of the driving shafts are made closer to the side of the seat frame with respect to the output shaft. Therefore, the amount of protrusion from the seat frame of the operation mechanism and the operation knob, which are arranged on the opposite side of the seat frame with the driving shafts interposed therebetween, is reduced. In this way, it is possible to secure a wide space between the operation part and members in the vicinity of the seat. As a result, it is possible to suppress the degradation of operability due to a small operation space of the operation part.

According to a second aspect, there is provided the seat drive device according to the first aspect, wherein a diameter of the gear of each of the plurality of the driving shafts is smaller than an outer diameter of the motor.

According to the second aspect, the driving shafts can be arranged on a seat frame side by utilizing the space provided for arranging the motor. Therefore, it is possible to suppress the space required for arranging the motor and the driving shafts.

According to a third aspect, there is provided the seat drive device according to the first or second aspect, wherein the output shaft of the motor is disposed between the driving shafts, and the driving shafts are configured to be directly driven by a gear provided on the output shaft of the motor.

According to the third aspect, since the power of the motor output shaft is directly transmitted to each of the driving shafts, the transmission efficiency can be improved. Further, since the motor output shaft can be arranged by utilizing gaps between the driving shafts arranged in parallel to each other, it is possible reduce the space required for arranging the driving shafts and the motor output shaft.

According to a fourth aspect, there is provided the seat drive device according to the first or second aspect, wherein the output shaft of the motor is disposed between the driving shafts, and the driving shafts are gear-engaged with the output shaft of the motor.

What is claimed is:

1. A seat drive device for a seat in which a seat frame serving as a framework member is arranged along an outer shape of the seat and positions of a plurality of seat moving parts are adjustable, the seat drive device comprising:
a motor fixed to an outer portion of the seat frame and having a single output shaft;
a plurality of driving shafts arranged in parallel and configured to receive output of the motor via a gear;
a plurality of position adjustment mechanisms configured to be actuated by the respective driving shafts and configured to adjust the positions of the respective seat moving parts;
a plurality of clutch mechanisms disposed corresponding to the respective position adjustment mechanisms and configured to individually and selectively connect output shafts to the respective position adjustment mechanisms and the driving shafts;
a switch configured to switch the motor to an energized state or a non-energized state;
an operation knob configured to be operated when adjusting the positions of the respective seat moving parts; and
an operation mechanism configured to switch the respective clutch mechanisms to a connected state or a non-connected state and configured to operate the switch by receiving an operating force of the operation knob,
wherein the operation mechanism and the operation knob are disposed on an opposite of the seat frame with the driving shafts interposed therebetween, and
wherein the output shaft of the motor and the plurality of driving shafts are arranged in parallel to each other such that an axis of the output shaft of the motor and axes of the plurality of driving shafts extend along the outer portion of the seat frame, and each distance between each of the plurality of driving shafts and the outer portion of the seat frame is smaller than a distance between the output shaft of the motor and the outer portion of the seat frame.

2. The seat drive device according to claim 1,
wherein a diameter of the gear of each of the plurality of the driving shafts is smaller than an outer diameter of the motor.

3. The seat drive device according to claim 1,
wherein the output shaft of the motor is disposed between the driving shafts, and the driving shafts are configured to be directly driven by a gear provided on the output shaft of the motor.

4. The seat drive device according to claim 1,
wherein the output shaft of the motor is disposed between the driving shafts, and the driving shafts are gear-engaged with the output shaft of the motor.
